(19) United States
(12) Patent Application Publication
(10) Pub. No.: US 2009/0156735 A1
(43) Pub. Date: Jun. 18, 2009

(54) COMPOSITION, ARTICLE, AND ASSOCIATED METHOD

(75) Inventors: Rainer Koeniger, Clifton Park, NY (US); Jason Joseph Testa, Greenville, SC (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/956,913

(22) Filed: Dec. 14, 2007

(51) Int. Cl. C08F 2/00; C08F 210/00

(52) U.S. Cl. 524/570; 526/348

(57) ABSTRACT

A composition includes a post-cured polymer. A post-cured polymer is formed from a polymer that is a reaction product of a polyfunctional cycloolefin and a metathesis catalyst. The post-cured polymer has a glass transition temperature in a range that is greater than 340 degrees Celsius. An associated article and a method are also provided.

### BACKGROUND

1. Technical Field

The invention includes embodiments that relate to cycloolefin-based post-cured composition and article formed therefrom. The invention includes embodiments that relate to a method of making the cycloolefin-based post-cured composition and article.

2. Discussion of Related Art

Metathesis polymerization reactions (for example, ring opening metathesis polymerization of cycloolefins) may provide for synthesis of polycycloolefins by controlled polymerization reaction. Polymers synthesized by ring opening metathesis polymerization may be reinforced with reinforcing materials (for example, fibers) to provide composites for high performance applications.

However, currently available polycycloolefin compositions and composites may exhibit low glass transition temperature (T_{g}). Further, these materials may lack a desirable level of dimensional integrity or stiffness when subjected to elevated temperatures, which may limit the use of these materials in high temperature applications.

It may be desirable to have cycloolefin compositions and composites with characteristics that differ from those characteristics of currently available cycloolefin compositions. It may be desirable to have cycloolefin compositions and composites produced by methods that differ from those methods currently available.

### BRIEF DESCRIPTION

In one embodiment, a composition is provided that includes a post-cured polymer. The post-cured polymer is formed from a polymer that is a reaction product of: a polyfunctional cycloolefin having two or more metathesis-active double bonds and a metathesis catalyst. The post-cured polymer has a glass transition temperature in a range that is greater than 340 degrees Celsius.

In one embodiment, a composition is provided that includes a post-cured polymer formed from a polymer that is the result of metathesis polymerization of a polyfunctional cycloolefin initiated by a metathesis catalyst. The polymer is post-cured at a temperature that is greater than an onset temperature for secondary curing of the polymer. The polyfunctional cycloolefin includes two or more metathesis-active double bonds.

In one embodiment, a composition is provided that includes a post-cured polymer. A post-cured polymer is formed from a polymer that is a reaction product of a polyfunctional cycloolefin having two or more metathesis-active double bonds and a metathesis catalyst. The post-cured polymer has a glass transition temperature that is greater than 340 degrees Celsius, and the post-cured polymer has an olefinic carbon content that is less than about 35 percent.

In one embodiment, a method is provided that includes initiating a metathesis polymerization of a polyfunctional cycloolefin by a metathesis catalyst, and post-curing the resulting polymer at a temperature that is greater than an onset temperature for secondary curing of the polymer. The polyfunctional cycloolefin includes two or more metathesis-active double bonds.

### BRIEF DESCRIPTION OF DRAWING FIGURES

FIG. 1 shows the reaction scheme for ring-opening metathesis polymerization of dicyclopentadiene.

FIG. 2 shows the DSC thermogram of DCPD.

FIG. 3 shows the DMA graphs of storage modulus as a function of temperature for post-cured DCPD samples.

FIG. 4 shows the glass transition temperatures measured as a function of post-curing temperature for post-cured DCPD samples.

FIG. 5 shows the solid-state ¹³C NMR spectra of post-cured DCPD samples.

FIG. 6 shows the DMA graphs of storage modulus as a function of temperature for post-cured DCPD samples and polyfunctional norbornene samples.

### DETAILED DESCRIPTION

The invention includes embodiments that relate to cycloolefin-based post-cured composition and article formed therefrom. The invention includes embodiments that relate to a method of making the cycloolefin-based post-cured composition and article.

In one embodiment, a composition is provided that includes a post-cured polymer. A post-cured polymer includes a reaction product of a polyfunctional cycloolefin having two or more metathesis-active double bonds and a metathesis catalyst, and has a glass transition temperature that is greater than 340 degrees Celsius. Glass transition temperature as defined herein may be measured by Dynamic Mechanical Analysis (DMA) on a resin bar (having dimensions of about 2 inch×0.5 inch×0.12 inch) in a TA Instruments RDA 3 model fitted with a torsion rectangular fixture, operating at a frequency of 10 radians/second and a heating rate of 2 degrees Celsius/minute.

In one embodiment, a post-cured polymer may include a reaction product of a cured polymer that has been subjected to a post-curing reaction. Curing, as used herein, may refer to a reaction resulting in polymerization, cross-linking, or both polymerization and cross-linking of a curable material. A curable material (for example, cycloolefin) may refer to a material having one or more reactive groups (for example, metathesis-active bonds in the cycloolefin) that may participate in a chemical reaction when exposed to one or more of thermal energy, electromagnetic radiation, or chemical reagents.

In one embodiment, curing may refer to ring opening of the metathesis-active double bonds of the cycloolefin to form a cured polymer. Cured polymer may refer to a polycycloolefin wherein more than about 50 percent of the metathesis-active bonds have reacted by ROMP, or alternatively a percent conversion of the metathesis active bonds is in a range that is greater than about 50 percent. Percent conversion may refer to a percentage of the total number of reacted groups (ring-opened double bonds) to the total number of reactive groups (ring double bonds).

In one embodiment, a percent conversion of the metathesis-active bonds in the cured polymer may be in a range that is greater than about 60 percent, greater than about 70 percent, greater than about 80 percent, greater than about 90 percent, or greater than about 99 percent. In one embodiment, a percent conversion of the metathesis-active bonds in the cured polymer may be in a range of about 100 percent.

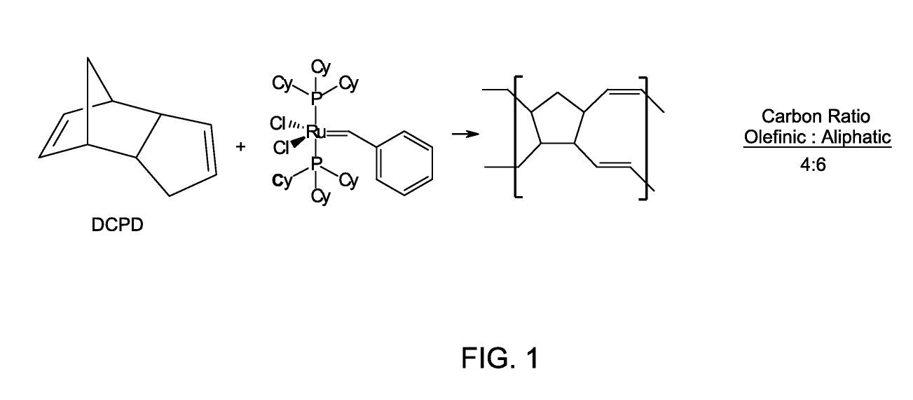

In one embodiment, a cured polymer may be characterized by a ratio of the olefinic carbon to the aliphatic carbon in the cured polymer, or alternatively percentage olefinic carbon content in the cured polymer relative to the total carbon content (olefinic and aliphatic carbon). In one embodiment, a cured polymer may have a ratio of the olefinic carbon to the aliphatic carbon that is greater than about 4:6. In one embodiment, a cured polymer may have a percentage olefinic carbon content that is greater than about 40 percent. In one embodiment, a percentage olefinic carbon content may be determined by ¹³C NMR spectroscopy. FIG. 1 shows an example of a cured polymer formed by ROMP of dicyclopentadiene having a ratio of olefinic to aliphatic carbon in a range of about 4:6.

Post-curing, as used herein, may refer to a reaction resulting in a secondary curing reaction of a cured polymer when exposed to one or more of thermal energy, electromagnetic radiation, or chemical reagents. Post-cured polymer, as used herein, may refer to a reaction product of a cured polymer that has undergone a secondary curing reaction. In one embodiment, a post-cured polymer may include a reaction product of a cured polymer wherein more than about 40 percent of the olefinic carbon in the cycloolefin has reacted, or alternatively a post-cured polymer may have a percent olefinic carbon content in a range that is less than about 40 percent.

In one embodiment, a composition is provided. A composition includes a post-cured polymer. A post-cured polymer includes a reaction product of a polyfunctional cycloolefin and a metathesis catalyst, and the post-cured polymer has a glass transition temperature in a range that is greater than 340 degrees Celsius, and the post-cured polymer has an olefinic carbon content in a range that is less than about 35 percent. In one embodiment, a post-cured polymer may have a percent olefinic carbon content in a range that is less than about 35 percent, that is less than about 30 percent, that is less than about 25 percent, or that is less than about 20 percent. In one embodiment, a post-cured polymer may include crosslinked polymeric species derived from a polyfunctional cycloolefin.

A post-cured polymer, as described herein, may be characterized by one or more physical properties, for example, glass transition temperature. In one embodiment, a post-cured polymer may have a glass transition temperature in a range of from about 350 degrees Celsius to about 360 degrees Celsius, from about 360 degrees Celsius to about 370 degrees Celsius, from about 370 degrees Celsius to about 380 degrees Celsius, from about 380 degrees Celsius to about 390 degrees Celsius, or from about 390 degrees Celsius to about 400 degrees Celsius. In one embodiment, a post-cured polymer may have a glass transition temperature in a range that is greater than about 400 degrees Celsius. In one embodiment, a post-cured polymer may have a glass transition temperature that is greater than a decomposition temperature of the post-cured polymer as measured by dynamic mechanical analysis (DMA). Here and throughout the specification and claims, range limitations may be combined and/or interchanged. Such ranges as identified include all the sub-ranges contained therein unless context or language indicates otherwise.

In one embodiment, a post-cured polymer may be characterized by improved high-temperature physical properties (for example, storage modulus) when compared to a cured polymer. In one embodiment, a post-cured polymer may have a storage modulus value in a range that is greater than about 2×10⁹ dynes/cm² at about 350 degrees Celsius, greater than about 3×10⁹ dynes/cm² at about 350 degrees Celsius, greater than about 4×10⁹ dynes/cm² at about 350 degrees Celsius, greater than about 5×10⁹ dynes/cm² at about 350 degrees Celsius, or greater than about 6×10⁹ dynes/cm² at about 350 degrees Celsius.

In one embodiment, a post-cured polymer may have a storage modulus value in a range that is greater than about 5×10⁹ dynes/cm² at about 250 degrees Celsius, that is greater than about 5×10⁹ dynes/cm² at about 275 degrees Celsius, that is greater than about 5×10⁹ dynes/cm² at about 300 degrees Celsius, that is greater than about 5×10⁹ dynes/cm² at about 315 degrees Celsius, that is greater than about 5×10⁹ dynes/cm² at about 335 degrees Celsius, that is greater than about 5×10⁹ dynes/cm² at about 350 degrees Celsius, or that is greater than about 5×10⁹ dynes/cm² at about 375 degrees Celsius. Storage modulus may be measured by Dynamic Mechanical Analysis (DMA) on a resin bar (2 inch×0.5 inch×0.12 inch) in a TA Instruments RDA 3 model fitted with a torsion rectangular fixture at a frequency of 10 radians/second and a heating rate of 2 degrees Celsius/minute.

In one embodiment, a post-cured polymer may have a number average molecular weight in a range from about 100000 grams per mole to about 250000 grams per mole, from about 250000 grams per mole to about 500000 grams per mole, or from about 500000 grams per mole to about 1000000 grams per mole. In one embodiment, a post-cured polymer may have a number average molecular weight in a range that is greater than about 1000000 grams per mole.

In one embodiment, post-curing of a cured polymer may be effected by heating a cured polymer at a temperature greater than an onset temperature for secondary curing reaction of the polymer. In one embodiment, an onset temperature for secondary curing of a cured polymer may be in a range greater than about 250 degrees Celsius. In one embodiment, a cured polymer may be post-cured at a temperature in a range of from about 250 degrees Celsius to about 260 degrees Celsius, from about 260 degrees Celsius to about 270 degrees Celsius, from about 270 degrees Celsius to about 280 degrees Celsius, from about 280 degrees Celsius to about 290 degrees Celsius, or from about 290 degrees Celsius to about 300 degrees Celsius. In one embodiment, a cured polymer may be post-cured at a temperature in a range that is greater than 300 degrees Celsius and less than the decomposition temperature of the cured polymer.

In one embodiment, post-curing a polymer at a temperature that is greater than an onset temperature for secondary curing may result in an increase in glass transition temperature of a post-cured polymer by greater than about 200 degrees Celsius relative to the glass transition temperature of a cured polymer heated to a temperature less than the onset temperature for the secondary curing reaction.

In one embodiment, a composition is provided. A composition includes a post-cured polymer produced by metathesis polymerization of a polyfunctional cycloolefin initiated by a metathesis catalyst, and post-curing the resulting cured polymer at a temperature that is greater than an onset temperature for secondary curing of a cured polymer.

As described hereinabove a post-cured polymer is a reaction product of a polyfunctional cycloolefin and a metathesis catalyst. A “cycloolefin” refers to an organic molecule having as a moiety at least one non-aromatic cyclic ring, and in which the non-aromatic ring has at least one carbon-carbon double bond, and of those carbon-carbon double bonds at least one is a metathesis-active double bond. A metathesis-active double bond includes a bond that is capable of undergoing a metathesis reaction in the presence of a metathesis catalyst. A metathesis reaction of an olefin refers to a chemical reaction involving redistribution of alkene bonds. In one embodiment, a metathesis-active double bond in the cycloolefin is capable of undergoing a ring-opening metathesis polymerization reaction in the presence of a metathesis catalyst.

Within the group of cycloolefins, a “polyfunctional cycloolefin” refers to those molecules that further have two or more metathesis-active double bonds. A polyfunctional cycloolefin further includes at least one carbon-carbon double bond that is capable of undergoing a secondary curing reaction that is not a metathesis reaction when subjected to the post-curing reaction conditions.

In one embodiment, one or more metathesis-active double bond in the polyfunctional cycloolefin itself may be capable of undergoing a secondary curing reaction after the redistribution of alkene bonds due to ROMP reaction of a cycloolefin. In an alternate embodiment, a polyfunctional cycloolefin may have a plurality of carbon-carbon double bonds in the cyclic ring, and of those carbon-carbon double bonds at least two may be a metathesis-active double bonds and at least one other may be capable of undergoing a secondary curing reaction that is not a metathesis reaction. In one embodiment, even though all of the double bonds in a polyfunctional cycloolefin may, for example, be metathesis-active there may be at least a difference in activation energy from one double bond to another to allow for one metathesis active double bond to the polymerized by ROMP and another double bond to be polymerized by a secondary curing reaction.

In one embodiment, a polyfunctional cycloolefin may include at least three metathesis-active double bonds, at least four metathesis-active double bonds, at least five metathesis-active double bonds, at least six metathesis-active double bonds, at least seven metathesis-active double bonds, or at least eight metathesis-active double bonds. In one embodiment, a polyfunctional cycloolefin may include at least nine metathesis-active double bonds.

In one embodiment, a polyfunctional cycloolefin may include one or more heteroatoms. A heteroatom is an atom other than carbon and hydrogen, and may include the group 15, group 16 or group 17 atom of the periodic table. In one embodiment, a heteroatom may include N, O, P, S, As or Se atoms. In one embodiment, a polyfunctional cycloolefin may include one or more functional groups either as substituents of the second cycloolefin or incorporated into the carbon chain of a second cycloolefin. Suitable functional groups may include one or more of alcohol, thiol, ketone, aldehyde, ester, disulfide, carbonate, imine, carboxyl, amine, amide, nitro acid, carboxylic acid, isocyanate, carbodiimide, ether, halogen, quaternary amine, phosphate, sulfate, or sulfonate.

In one embodiment, a polyfunctional cycloolefin may include a structure having a formula (I)

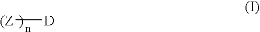

wherein “n” is 2, 3, 4, 5, 6, 7, or 8;
D is a n-valent aliphatic, cycloaliphatic, or an aromatic bridging group; and
Z includes at least one cycloolefin group. A cycloolefin is as described hereinabove. In one embodiment, Z may include a cyclopentene radical, a cycloheptene radical, a cyclooctene radical, a cyclopentadiene radical, or a norbornene radical.

In one embodiment, a polyfunctional cycloolefin may include a structure having a formula (II):

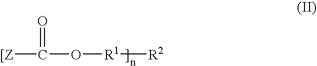

wherein “n” is 2, 3, 4, 5, 6, 7, or 8;
R¹ is an aliphatic radical, a cycloaliphatic radical, or an aromatic radical;
R² is a n-valent aliphatic radical, a n-valent cycloaliphatic radical, or a n-valent aromatic radical; and
Z includes at least one cycloolefin group. Aliphatic radical, cycloaliphatic radical, and aromatic radical may be defined as the following:

Aliphatic radical is an organic radical having at least one carbon atom, a valence of at least one and may be a linear or branched array of atoms. Aliphatic radicals may include heteroatoms such as nitrogen, sulfur, silicon, selenium and oxygen or may be composed exclusively of carbon and hydrogen. Aliphatic radical may include a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example, carboxylic acid derivatives such as esters and amides), amine groups, nitro groups and the like. For example, the 4-methylpent-1-yl radical is a C₆ aliphatic radical comprising a methyl group, the methyl group being a functional group, which is an alkyl group. Similarly, the 4-nitrobut-1-yl group is a C₄ aliphatic radical comprising a nitro group, the nitro group being a functional group. An aliphatic radical may be a haloalkyl group that includes one or more halogen atoms, which may be the same or different. Halogen atoms include, for example; fluorine, chlorine, bromine, and iodine. Aliphatic radicals having one or more halogen atoms include the alkyl halides: trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (—CONH₂), carbonyl, dicyanoisopropylidene —CH₂C(CN)₂CH₂—), methyl (—CH₃), methylene (—CH₂—), ethyl, ethylene, formyl (—CHO), hexyl, hexamethylene, hydroxymethyl (—CH₂OH), mercaptomethyl (—CH₂SH), methylthio (—SCH₃), methylthiomethyl (—CH₂SCH₃), methoxy, methoxycarbonyl (CH₃OCO—), nitromethyl (—CH₂NO₂), thiocarbonyl, trimethylsilyl ((CH₃)₃Si—), t-butyldimethylsilyl, trimethoxysilylpropyl ((CH₃O)₃SiCH₂CH₂CH₂—), vinyl, vinylidene, and the like. By way of further example, a “C₁-C₃₀ aliphatic radical” contains at least one but no more than 30 carbon atoms. A methyl group (CH₃—) is an example of a C₁ aliphatic radical. A decyl group (CH₃(CH₂)₉—) is an example of a C₁₀ aliphatic radical.

A cycloaliphatic radical is a radical having a valence of at least one, and having an array of atoms, which is cyclic but which is not aromatic. A cycloaliphatic radical may include one or more non-cyclic components. For example, a cyclohexylmethyl group (C₆H₁₁CH₂—) is a cycloaliphatic radical, which includes a cyclohexyl ring (the array of atoms, which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. A cycloaliphatic radical may include one or more functional groups, such as alkyl groups, alkenyl groups, alkynyl groups, halo alkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups and the like. For example, the 4-methylcyclopent-1-yl radical is a C₆ cycloaliphatic radical comprising a methyl group, the methyl group being a functional group, which is an alkyl group. Similarly, the 2-nitrocyclobut-1-yl radical is a C₄ cycloaliphatic radical comprising a nitro group, the nitro group being a functional group. A cycloaliphatic radical may include one or more halogen atoms, which may be the same or different. Halogen atoms include, for example, fluorine, chlorine, bromine, and iodine. Cycloaliphatic radicals having one or more halogen atoms include 2-trifluoromethylcyclohex-1-yl; 4-bromodifluoromethylcyclooct-1-yl; 2-chlorodifluoromethylcyclohex-1-yl; hexafluoroisopropylidene 2,2-bis(cyclohex-4-yl) (—C₆H₁₀C(CF₃)₂C₆H₁₀—); 2-chloromethylcyclohex-1-yl; 3-difluoromethylenecyclohex-1-yl; 4-trichloromethylcyclohex-1-yloxy; 4-bromodichloromethylcyclohex-1-ylthio; 2-bromoethylcyclopent-1-yl; 2-bromopropylcyclohex-1-yloxy (e.g. CH₃CHBrCH₂C₆H₁₀—); and the like. Further examples of cycloaliphatic radicals include 4-allyloxy cyclohex-1-yl; 4-amino cyclohex-1-yl (H₂C₆H₁₀—); 4-amino carbonyl cyclopent-1-yl (NH₂COC₅H₈—); 4-acetyloxy cyclohex-1-yl; 2,2-dicyano isopropylidene bis(cyclohex-4-yloxy) (—OC₆H₁₀C(CN)₂C₆H₁₀O—); 3-methyl cyclohex-1-yl; methylenebis(cyclohex-4-yloxy) (—OC₆H₁₀CH₂C₆H₁₀O—); 1-ethyl cyclobut-1-yl; cyclopropylethenyl; 3-formyl-2-terahydro furanyl; 2-hexyl-5-tetrahydro furanyl; hexamethylene-1,6-bis(cyclohex-4-yloxy) (—OC₆H₁₀(CH₂)₆C₆H₁₀O—); 4-hydroxy methyl cyclohex-1-yl (4-HOCH₂C₆H₁₀—); 4-mercaptomethylcyclohex-1-yl (4-HSCH₂C₆H₁₀—); 4-methyl thio cyclohex-1-yl (4-CH₃SC₆H₁₀—); 4-methoxy cyclohex-1-yl; 2-methoxy carbonyl cyclohex-1-yloxy (2-CH₃OCOC₆H₁₀O—); 4-nitro methyl cyclohex-1-yl (NO₂CH₂C₆H₁₀—); 3-trimethyl silyl cyclohex-1-yl; 2-t-butyl dimethyl silyl cyclopent-1-yl; 4-trimethoxy silyl ethyl cyclohex-1-yl (e.g. (CH₃O)₃SiCH₂CH₂C₆H₁₀—); 4-vinyl cyclohexen-1-yl; vinylidene bis(cyclohexyl); and the like. The term “a C₃-C₃₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

An aromatic radical is an array of atoms having a valence of at least one and having at least one aromatic group. This may include heteroatoms such as nitrogen, sulfur, selenium, silicon and oxygen, or may be composed exclusively of carbon and hydrogen. Suitable aromatic radicals may include phenyl, pyridyl, furanyl, thienyl, naphthyl, phenylene, and biphenyl radicals. The aromatic group may be a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthracenyl groups (n=3) and the like. The aromatic radical also may include non-aromatic components. For example, a benzyl group may be an aromatic radical, which includes a phenyl ring (the aromatic group) and a methylene group (the non-aromatic component). Similarly a tetrahydronaphthyl radical is an aromatic radical comprising an aromatic group (C₆H₃) fused to a non-aromatic component —(CH₂)₄—. An aromatic radical may include one or more functional groups, such as alkyl groups, alkenyl groups, alkynyl groups, haloalkyl groups, haloaromatic groups, conjugated dienyl groups, alcohol groups, ether groups, thio groups, aldehyde groups, ketone groups, carboxylic acid groups, acyl groups (for example carboxylic acid derivatives such as esters and amides), amine groups, nitro groups, and the like. For example, the 4-methylphenyl radical is a C₇ aromatic radical comprising a methyl group, the methyl group being a functional group, which is an alkyl group. Similarly, the 2-nitrophenyl group is a C6 aromatic radical comprising a nitro group, the nitro group being a functional group. Aromatic radicals include halogenated aromatic radicals such as trifluoromethylphenyl; hexafluoro isopropylidene bis(4-phen-1-yloxy) (—OPhC(CF₃)₂PhO—); chloromethyl phenyl; 3-trifluorovinyl-2-thienyl; 3-trichloro methylphen-1-yl (3-CCl₃Ph-); 4-(3-bromoprop-1-yl)phen-1-yl (BrCH₂CH₂CH₂Ph-); and the like. Further examples of aromatic radicals include 4-allyloxyphen-1-oxy; 4-aminophen-1-yl (H₂NPh-); 3-aminocarbonylphen-1-yl (NH₂COPh-); 4-benzoylphen-1-yl; dicyano isopropylidene bis(4-phen-1-yloxy) (—OPhC(CN)₂PhO—); 3-methylphen-1-yl; methylene bis(phen-4-yloxy) (—OPhCH₂PhO—); 2-ethylphen-1-yl; phenylethenyl; 3-formyl-2-thienyl; 2-hexyl-5-furanyl; hexamethylene-1,6-bis(phen-4-yloxy) (—OPh(CH₂)₆PhO—); 4-hydroxymethylphen-1-yl (4-HOCH₂Ph-); 4-mercaptomethylphen-1-yl (4-HSCH₂Ph-); 4-thiophenyl (—S-Ph); 4-methylthiophen-1-yl (4-CH₃SPh-); 3-methoxyphen-1-yl; 2-methoxycarbonylphen-1-yloxy (e.g., methyl salicyl); 2-nitromethylphen-1-yl (-PhCH₂NO₂); 3-trimethylsilylphen-1-yl; 4-t-butyldimethylsilylphenl-1-yl; 4-vinylphen-1-yl; vinylidenebis(phenyl); and the like. The term “a C₃-C₃₀ aromatic radical” includes aromatic radicals containing at least three but no more than 30 carbon atoms. The aromatic radical 1-imidazolyl (C₃H₂N₂—) represents a C₃ aromatic radical. The benzyl radical (C₇H₇—) represents a C₇ aromatic radical.

In one embodiment, a polyfunctional cycloolefin may include a bifunctional cycloolefin. In one embodiment, a bifunctional cycloolefin may include two metathesis active bonds. In one embodiment, a bifunctional cycloolefin may include two norbornene functional groups. Some examples of bifunctional cycloolefins may include structures having a formula (III) to (XII):

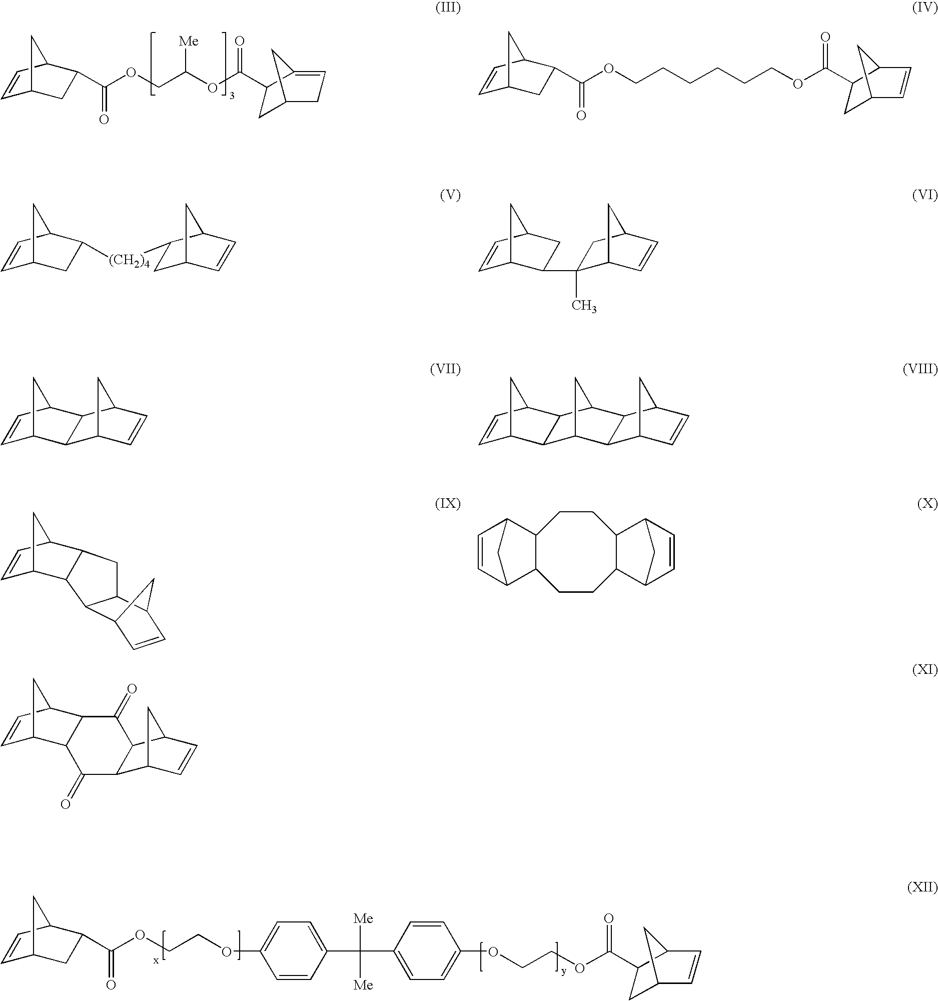

In one embodiment, a polyfunctional cycloolefin may include a trifunctional cycloolefin. In one embodiment, a trifunctional cycloolefin may include three metathesis-active double bonds. In one embodiment, a trifunctional cycloolefin may include three norbornene functional groups. Some examples of trifunctional cycloolefins may include structures having a formula (XIII) to (XIX):

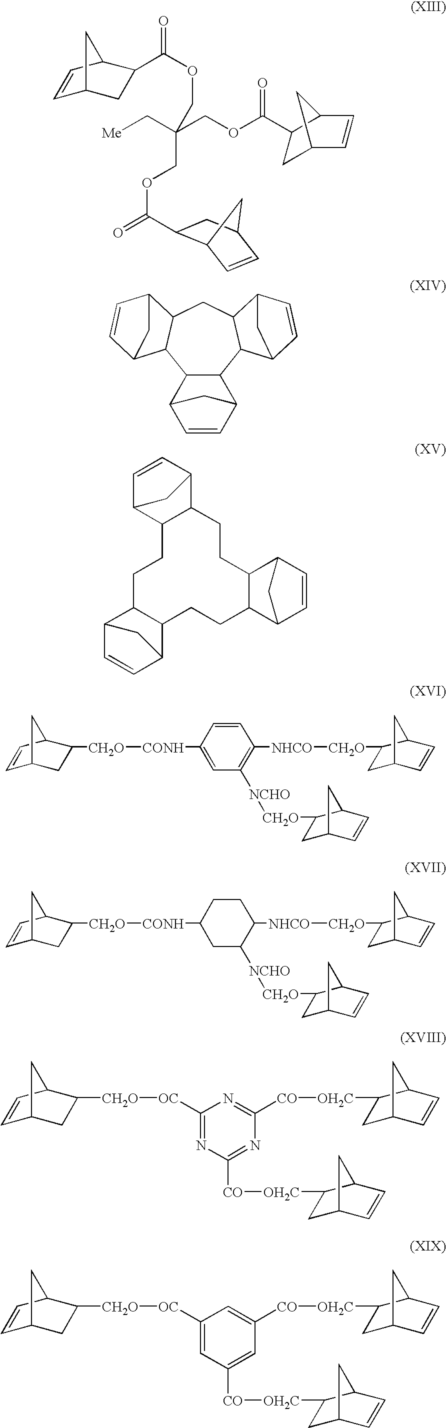

In one embodiment, a polyfunctional cycloolefin may include four or more metathesis-active double bonds. In one embodiment, a polyfunctional cycloolefin may include four or more norbornene functional groups. Examples of polyfunctional cycloolefins may include structures having a formula (XX) to (XII):

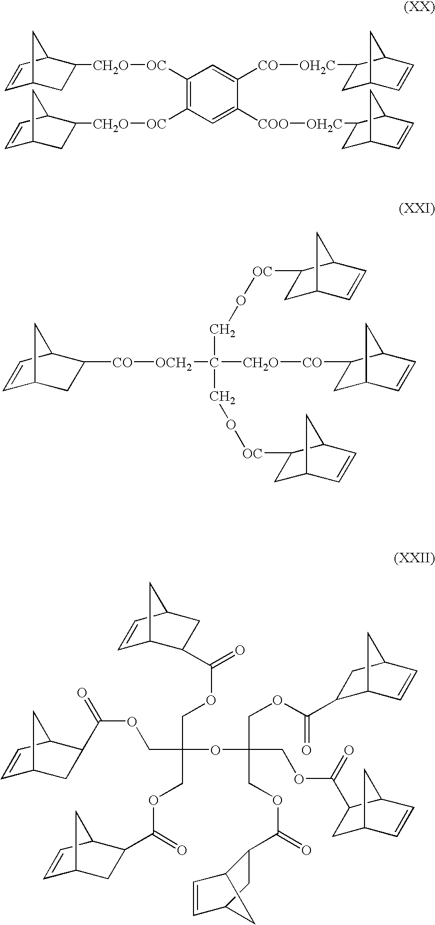

In one embodiment, a composition is provided. A composition includes a post-cured polymer including a reaction product of a monofunctional cycloolefin, a polyfunctional cycloolefin having two or more metathesis-active double bonds, and a metathesis catalyst. The post-cured polymer has a glass transition temperature that is greater than 340 degrees Celsius. A monofunctional cycloolefin as used herein refers to a cycloolefin having a single metathesis-active double bond. In one embodiment, a monofunctional cycloolefin may further include at least one carbon-carbon double bond that is capable of undergoing a secondary curing reaction that is not a metathesis reaction when subjected to the post-curing reaction conditions.

In one embodiment, a monofunctional cycloolefin may include a structure having a formula (XXIII):

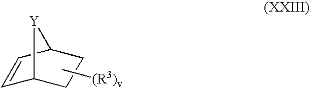

wherein “v” is 1, 2, 3, 4, 5, or 6;
R³ is independently at each occurrence hydrogen, a halogen atom, an aliphatic radical, a cycloaliphatic radical, an aromatic radical, an alkoxy group, a hydroxy group, an ether group, an aldehyde group, an ester group, a ketone group, a thiol group, a disulfide group, an amine group, an amide group, a quaternary amine group, an imine group, an isocyanate group, a carboxyl group, a silanyl group, a phosphanyl group, a sulfate group, a sulfonate group, a nitro group, or two or more R³ together form a cycloaliphatic radical, an aromatic radical, an imide group, or a divalent bond linking two carbon atoms; and
Y is C(R⁴)₂, C═C(R⁴)₂, Si(R⁴)₂, O, S, NR⁴, PR⁴, BR⁴, or AsR⁴, wherein R⁴ is independently at each occurrence hydrogen, an aliphatic radical, a cycloaliphatic radical, or an aromatic radical.

In one embodiment, a monofunctional cycloolefin may include two or more cyclic rings that may be fused with each other. In one embodiment, a monofunctional cycloolefin may include Diels-Alder adducts of two or more cyclopentadienes. In one embodiment, a monofunctional cycloolefin may include Diels-Alder adducts of cyclopentadiene and oligocyclopentadienes. In one embodiment, a monofunctional cycloolefin may include functionalized or unfunctionalized dicyclopentadiene.

In one embodiment, a monofunctional cycloolefin may include a structure having a formula (XXIV):

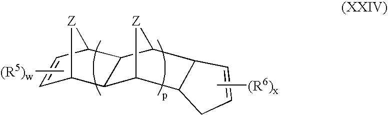

wherein “p” is an integer from 0 to 100; “w” is 1 or 2; “x” is 1, 2, 3, or 4;
R⁵ and R⁶ are independently at each occurrence hydrogen, a halogen atom, an aliphatic radical, a cycloaliphatic radical, an aromatic radical, an alkoxy group, a hydroxy group, an ether group, an aldehyde group, an ester group, a ketone group, a thiol group, a disulfide group, an amine group, an amide group, a quaternary amine group, an imine group, an isocyanate group, a carboxyl group, a silanyl group, a phosphanyl group, a sulfate group, a sulfonate group, a nitro group; and
Z is C(R⁷)₂, C═C(R⁷)₂, Si(R⁷)₂, O, S, NR⁷, PR⁷, BR⁷, or AsR⁷, wherein R⁷ is independently at each occurrence hydrogen, an aliphatic radical, a cycloaliphatic radical, or an aromatic radical.

In one embodiment, a monofunctional cycloolefin may include one or more of dicyclopentadiene, norbornene, oxanorbornene, norbornadiene, cyclooctadiene, cyclooctene, cyclotetraene, cyclodecene, cyclododecene, or a derivative thereof. In one embodiment, a monofunctional cycloolefin may include dicyclopentadiene.

In one embodiment, a composition may include a post-cured polymer having a reaction product of a curable composition. In one embodiment, a curable composition may include a polyfunctional cycloolefin and a metathesis catalyst. In one embodiment, a curable composition may include a polyfunctional cycloolefin, a monofunctional cycloolefin, and a metathesis catalyst.

In one embodiment, a monofunctional cycloolefin may ring open polymerize when contacted to a metathesis catalyst. In one embodiment, a monofunctional cycloolefin may copolymerize with the polyfunctional cycloolefin when contacted to a metathesis catalyst. In one embodiment, a post-cured polymer may include crosslinked polymeric species derived from a polyfunctional cycloolefin, a monofunctional cycloolefin, or both polyfunctional cycloolefin and monofunctional cycloolefin. In one embodiment, a post-cured polymer may include a reaction product of mixtures of cycloolefins chosen to provide the desired end-use properties. In one embodiment, one or more functional properties of a post-cured polymer produced using the mixtures of cycloolefins may be determined by the type of functional groups present and the number of functional groups present.

In one embodiment, a polyfunctional cycloolefin may be present in an amount in a range of from about 0.5 weight percent to about 1 weight percent of the combined weight of the composition. In one embodiment, a polyfunctional cycloolefin may be present in an amount in a range of from about 1 weight percent to about 5 weight percent of the combined weight of the composition, from about 5 weight percent to about 10 weight percent of the combined weight of the composition, from about 10 weight percent to about 25 weight percent of the combined weight of the composition, or from about 25 weight percent to about 50 weight percent of the combined weight of the composition. In one embodiment, a polyfunctional cycloolefin may be present in an amount that is greater than about 50 weight percent of the combined weight of the composition. In embodiments involving mixtures of cycloolefins, the combined weight of the cycloolefins may be present in an amount in a range of from about 0.5 weight percent to about 80 weight percent of the combined weight of the composition.

In one embodiment, a metathesis catalyst may include a transition metal catalyst. In one embodiment, a metathesis catalyst may include a tungsten or a molybdenum salt. In one embodiment, a metathesis catalyst may include a tungsten halide or a tungsten oxyhalide, activated by an alkyl aluminum compound.

In one embodiment, a metathesis catalyst may include ruthenium, osmium, or both ruthenium and osmium. In one embodiment, ruthenium or osmium may form a metal center of the catalyst. In one embodiment, Ru or Os in the catalyst may be in the +2 oxidation state, may have an electron count of 16, and may be penta-coordinated. In an alternate embodiment, Ru or Os in the catalyst may be in the +2 oxidation state, may have an electron count of 18, and may be hexa-coordinated.

In one embodiment, a metathesis catalyst may include a structure having a formula (XXV):

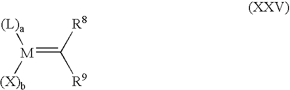

wherein “a” and “b” are independently integers from 1 to 3, with the proviso that “a+b” is less than or equal to 5;
M is ruthenium or osmium;
X is independently at each occurrence an anionic ligand;
L is independently at each occurrence a neutral electron donor ligand;
R⁸ is hydrogen, an aliphatic radical, a cycloaliphatic radical, or an aromatic radical;
R⁹ is an aliphatic radical, a cycloaliphatic radical, an aromatic radical, or S—R¹⁰; or R⁸ and R⁹ together form a cycloaliphatic radical or an aromatic radical; and
R¹⁰ is an aliphatic radical, a cycloaliphatic radical, or an aromatic radical.

A metathesis catalyst may include one or more neutral electron-donating ligand, one or more anionic ligand, and an alkylidene radical as shown hereinabove in formula (XXV). A neutral electron-donating ligand, an anionic ligand or an alkylidene radical may be bonded to the metal center by coordination bond formation. As used herein, the term “neutral electron-donating ligand” refers to ligands that have a neutral charge when removed from the metal center. As used herein the term “alkylidene radical” refers to a substituted or unsubstituted divalent organic radical formed from an alkane by removal of two hydrogen atoms from the same carbon atom, the free valencies of which are part of a double bond. In one embodiment, a carbon atom in the alkylidene radical may form a double bond with the metal center in the metal complex. A carbon atom in the alkylidene radical may be substituted with R⁸ and R⁹, wherein R⁸ and R⁹ are as defined hereinabove.

An anionic ligand X in formula (XXV) may be a unidentate ligand or bidentate ligand. In one embodiment, X in formula (XXV) may be independently at each occurrence a halide, a carboxylate, a sulfonate, a sulfonyl, a sulfinyl, a diketonate, an alkoxide, an aryloxide, a cyclopentadienyl, a cyanide, a cyanate, a thiocyanate, an isocyanate, or an isothiocyanate. In one embodiment, X in formula (XXV) may be independently at each occurrence chloride, fluoride, bromide, iodide, CF₃CO₂, CH₃CO₂, CFH₂CO₂, (CH₃)₃CO, (CF₃)₂(CH₃)CO, (CF₃)(CH₃)₂CO, PhO, MeO, EtO, tosylate, mesylate, or trifluoromethanesulfonate.

The number of anionic ligands X bonded to the metal center may depend on one or more of the coordination state of the transition metal (for example, penta-coordinated or hexa-coordinated), the number of neutral electron donating ligands bonded to the transition metal, or dentency of the anionic ligand. In one embodiment, X in formula (XXV) may include a unidentate anionic ligand and “b” may be 2. In one embodiment, X in formula (XXV) may include a bidentate anionic ligand and “b” may be 1. In one embodiment, X in formula (XXV) may be independently at each occurrence a chloride and “b’ may be 2.

In one embodiment, an electron donor ligand L in formula (XXV) may be independently at each occurrence a monodentate, a bidentate, a tridentate, or a tetradentate neutral electron donor ligand. In one embodiment, at least one L may be phosphine, phosphite, phosphinite, phosphonite, arsine, stilbine, ether, amine, amide, imine, sulfoxide, carboxyl, nitrosyl, or thioethene. In one embodiment, at least one L may be a phosphine having formula P(R¹¹R¹²R¹³), where R¹¹, R¹², and R¹³ are each independently an aliphatic radical, a cycloaliphatic radical, or an aromatic radical. In one embodiment, at least L may include P(cyclohexyl)₃, P(cyclopentyl)₃, P(isopropyl)₃, or P(phenyl)₃.

In one embodiment, at least one L may be a heterocyclic ligand. A heterocyclic ligand refers to an array of atoms forming a ring structure and including one or more heteroatoms as part of the ring, where heteroatoms are as defined hereinabove. A heterocyclic ligand may be aromatic (heteroarene ligand) or non-aromatic, wherein a non-aromatic heterocyclic ligand may be saturated or unsaturated. A heterocyclic ligand may be further fused to one or more cyclic ligand, which may be a heterocycle or a cyclic hydrocarbon, for example in indole.

In one embodiment, at least one L may be a heteroarene ligand. A heteroarene ligand refers to an unsaturated heterocyclic ligand in which the double bonds form an aromatic system. In one embodiment, at least one L is furan, thiophene, pyrrole, pyridine, bipyridine, picolylimine, gamma-pyran, gamma-thiopyran, phenanthroline, pyrimidine, bipyrimidine, pyrazine, indole, coumarone, thionaphthene, carbazole, dibenzofuran, dibenzothiophene, pyrazole, imidazole, benzimidazole, oxazole, thiazole, dithiazole, isoxazole, isothiazole, quinoline, bisquinoline, isoquinoline, bisisoquinoline, acridine, chromene, phenazine, phenoxazine, phenothiazine, triazine, thianthrene, purine, bisimidazole, or bisoxazole. In one embodiment, at least one L may be a monodentate heteroarene ligand, which may be unsubstituted or substituted, for example, pyridine. In one embodiment at least one L may be a bidentate heteroarene ligand, which may be substituted or unsubstituted, for example, bipyridine, phenanthroline, bithiazole, bipyrimidine, or picolylimine.

In one embodiment, at least one L may be a N-heterocyclic carbene ligand (NHC). A N-heterocyclic carbene ligand is a heterocyclic ligand including at least one N atom in the ring and a carbon atom having a free electron pair. Examples of NHC ligands may include ligands of formula (XXVI), (XXVII), or (XXVIII):

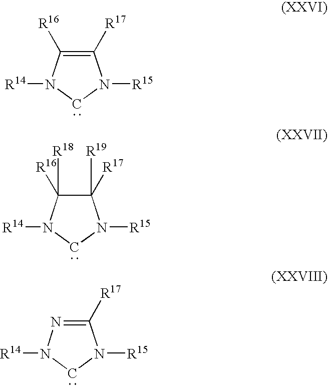

wherein R¹⁴, R¹⁵, R¹⁶, R¹⁷, R¹⁸, or R¹⁹ may be independently at each occurrence hydrogen, an aliphatic radical, a cycloaliphatic radical, or an aromatic radical. In one embodiment, R¹⁶, R¹⁷, R¹⁸, and R¹⁹ may be independently at each occurrence hydrogen. In one embodiment, R¹⁴ and R¹⁵ may be independently at each occurrence a substituted or an unsubstituted aromatic radical.

In one embodiment, a N-heterocyclic carbene ligand may include 1,3-dimesitylimidazolidin-2-ylidene; 1,3-di(1-adamantyl)imidazolidin-2-ylidene; 1-cyclohexyl-3-mesitylimidazolidin-2-ylidene; 1,3-dimesityl octahydro benzimidazol—2-ylidene; 1,3-diisopropyl-4-imidazolin-2-ylidene; 1,3-di(1-phenylethyl)-4-imidazolin-2-ylidene; 1,3-dimesityl-2,3-dihydrobenzimidazol-2-ylidene; 1,3,4-triphenyl-2,3,4,5-tetrahydro-1H-1,2,4-triazol-5-ylidene; 1,3-dicyclohexylhexahydro pyrimidin-2-ylidene; N,N,N′,N′-tetraisopropyl formamidinylidene; 1,3,4-triphenyl-4,5-dihydro-1H-1,2,4-triazol-5-ylidene; or 3-(2,6-diisopropylphenyl)-2,3-dihydrothiazol-2-ylidene.

The number of neutral electron donor ligands L bonded to the transition metal may depend on one or more of the coordination state of the transition metal (for example, penta-coordinated or hexa-coordinated), the number of anionic ligands bonded to the transition metal, or dentency of the neutral electron donor ligand. In one embodiment, “a” in formula (XXV) may be 1. In one embodiment, “a” in formula (XXV) may be 2. In one embodiment, “a” in formula (XXV) may be 3. In one embodiment, R⁸, R⁹, X and L may be bound to one another in an arbitrary combination to form a multidentate chelate ligand. In one embodiment two or more of R⁸, R⁹, X or L may independently form a cyclic ring, for example, R⁸ and R⁹ may together form a substituted or unsubstituted indene group.

In one embodiment, at least one L in formula (XXV) may include a phosphine ligand. In one embodiment, at least one L in formula (XXV) may include P(cyclohexyl)₃, P(cyclopentyl)₃, P(isopropyl)₃, or P(phenyl)₃. In one embodiment, at least one L in formula (XXV) may include a monodentate pyridine ligand, which is unsubstituted or substituted. In one embodiment, at least one L in formula (XXV) may include a bromine-substituted monodentate pyridine ligand. In one embodiment, at least one L in formula (XXV) may include a N-heterocyclic carbene ligand (NHC). In one embodiment, at least one L in formula (XXV) may include an NHC ligands having formula (XXVI), (XXVII), or (XXVIII).

In one embodiment, R⁹ in formula (XXV) may include an aromatic radical. In one embodiment, R⁹ in formula (XXV) may include a substituted or an unsubstituted benzyl radical. In one embodiment, at least one X in formula (XXV) may include a halide. In one embodiment, at least one X in formula (XXV) may include a chloride.

In one embodiment, the composition having a formula (XXV) may include Bis(tricyclohexylphosphine)benzylidine ruthenium (IV) chloride (CAS No. 172222-30-9), 1,3-Bis(2,4,6-trimethylphenyl)-2-imidazolidinylidene)dichloro (phenylmethylene)(tricyclohexylphosphine)ruthenium (CAS No. 246047-72-3), 1,3-Bis(2,4,6-trimethylphenyl)-2-imidazolidinylidene)dichloro(phenylmethylene)(di-3-bromopyridine)ruthenium, or 1,3-Bis-(2,4,6-trimethylphenyl)-2-imidazolidinylidene)dichloro(o-isopropoxyphenyl methylene)ruthenium (CAS No. 301224-40-8).

In one embodiment, the composition having a formula (XXII) may include Bis(tricyclohexylphosphine)benzylidine ruthenium (IV) chloride (CAS No. 172222-30-9), 1,3-Bis(2,4,6-trimethylphenyl)-2-imidazolidinylidene)dichloro(phenylmethylene)(tricyclohexylphosphine)ruthenium (CAS No. 246047-72-3), 1,3-Bis(2,4,6-trimethylphenyl)-2-imidazolidinylidene)dichloro(phenylmethylene)(di-3-bromopyridine)ruthenium, or 1,3-Bis-(2,4,6-trimethylphenyl)-2-imidazolidinylidene)dichloro(o-isopropoxyphenyl methylene)ruthenium (CAS No. 301224-40-8).

The metathesis catalyst may be present in an amount greater than about 0.001 weight percent based on the combined weight of the composition. In one embodiment, a metathesis catalyst may be present in an amount in a range of from about 0.001 weight percent to about 0.002 weight percent of the combined weight of the composition, from about 0.002 weight percent to about 0.005 weight percent of the combined weight of the composition, or from about 0.005 weight percent to about 0.01 weight percent of the combined weight of the composition. In one embodiment, a metathesis catalyst may be present in an amount in a range of from about 0.01 weight percent to about 0.02 weight percent of the combined weight of the composition, from about 0.02 weight percent to about 0.03 weight percent of the combined weight of the composition, from about 0.03 weight percent to about 0.05 weight percent of the combined weight of the composition, or from about 0.05 weight percent to about 0.1 weight percent of the combined weight of the composition. In one embodiment, a metathesis catalyst may be present in an amount that is greater than about 0.1 weight percent of the combined weight of the composition.

In one embodiment, a metathesis catalyst may initiate a ring opening metathesis polymerization reaction when contacted to a monofunctional cycloolefin or a polyfunctional cycloolefin. In one embodiment, the conversion of the cycloolefin(s) may be complete, that is, the reaction product may be free of any unreacted cycloolefin(s). In one embodiment, the conversion of the cycloolefin(s) may be incomplete, that is, the reaction product may include unreacted cycloolefin(s). In one embodiment, the conversion of the cycloolefin(s) may be in a range that is greater than about 50 weight percent. In one embodiment, the conversion of the cycloolefin(s) may be in a range of from about 50 weight percent to about 60 weight percent, from about 60 weight percent to about 70 weight percent, from about 70 weight percent to about 80 weight percent, from about 80 weight percent to about 90 weight percent, or from about 90 weight percent to about 100 weight percent.

The curable composition may include a reaction control agent. A reaction control agent may be added to control the pot life of the reaction mixture. In one embodiment, a reaction control agent may include a neutral electron donor or a neutral Lewis base. Suitable reaction control agents may include one or more of phosphines, sulfonated phosphines, phosphites, phosphinites, or phosphonites. Other suitable reaction control agents may include one or more of arsines, stibines, sulfoxides, carboxyls, ethers, thioethers, or thiophenes. Yet other suitable reaction control agents may include one or more of amines, amides, nitrosyls, pyridines, nitriles, or furans. In one embodiment, an electron donor or a Lewis base may include one or more functional groups, such as hydroxyl; thiol; ketone; aldehyde; ester; ether; amine; amide; nitro acid; carboxylic acid; disulfide; carbonate; carboalkoxy acid; isocyanate; carbodiimide; carboalkoxy; and halogen. In one embodiment, a reaction control agent may include one or more of triphenylphosphine, tricyclopentylphosphine, tricyclohexylphosphine, triphenylphosphite, pyridine, propylamine, tributylphosphine, benzonitrile, triphenylarsine, anhydrous acetonitrile, thiophene, or furan. In one embodiment, a reaction control agent may include one or more of P(cyclohexyl)₃, P(cyclopentyl)₃, P(isopropyl)₃, P(Phenyl)₃, or pyridine.

Optionally, the curable composition may include one or more additives. Suitable additives may be selected with reference to performance requirements for particular applications. For example, a fire retardant additive may be selected where fire retardancy may be desired, a flow modifier may be employed to affect rheology or thixotropy, a reinforcing filler may be added where reinforcement may be desired, and the like. The additives may include one or more of flow control agents, modifiers, carrier solvents, viscosity modifiers, adhesion promoters, ultra-violet absorbers, flame-retardants, or reinforcing fillers. Defoaming agents, dyes, pigments, and the like may also be incorporated into composition. The amount of such additives may be determined by the end-use application.

In one embodiment, an article is provided. An article includes a filler and post-cured polymer. A post-cured polymer includes a reaction product of a polyfunctional cycloolefin and metathesis catalyst, and a post-cured polymer has a glass transition temperature in a range that is greater than 340 degrees Celsius.

A suitable filler may include one or more material selected from siliceous materials, carbonaceous materials, metal hydrates, metal oxides, metal borides, or metal nitrides. In one embodiment, the filler essentially may include carbonaceous materials. The filler may be particulate, fibrous, platelet, whiskers or rods, or a combination of two or more of the foregoing.

The filler may include a plurality of particles. The plurality of particles may be characterized by one or more of average particle size, particle size distribution, average particle surface area, particle shape, or particle cross-sectional geometry.

In one embodiment, an average particle size (average diameter) of the filler may be less than about 1 nanometer. In one embodiment, an average particle size of the filler may be in a range of from about 1 nanometer to about 10 nanometers, from about 10 nanometers to about 25 nanometers, from about 25 nanometers to about 50 nanometers, from about 50 nanometers to about 75 nanometers, or from about 75 nanometers to about 100 nanometers. In one embodiment, an average particle size of the filler may be in a range of from about 0.1 micrometers to about 0.5 micrometers, from about 0.5 micrometers to about 1 micrometer, from about 1 micrometer to about 5 micrometers, from about 5 micrometers to about 10 micrometers, from about 10 micrometers to about 25 micrometers, or from about 25 micrometers to about 50 micrometers. In another embodiment, an average particle size of the filler may be in a range of from about 50 micrometers to about 100 micrometers, from about 100 micrometers to about 200 micrometers, from about 200 micrometers to about 400 micrometers, from about 400 micrometers to about 600 micrometers, from about 600 micrometers to about 800 micrometers, or from about 800 micrometers to about 1000 micrometers. In one embodiment, an average particle size of the filler may be in a range of greater than about 1000 micrometers.

In another embodiment, filler particles having two distinct size ranges (a bimodal distribution) may be included in the composition: the first range from about 1 nanometers to about 500 nanometers, and the second range from about 0.5 micrometer (or 500 nanometers) to about 1000 micrometers (the filler particles in the second size range may be herein termed “micrometer-sized fillers”).

Filler particle morphology can be selected to include shapes and cross-sectional geometries based on the process used to produce the particles. In one embodiment, a filler particle may be a sphere, a rod, a tube, a flake, a fiber, a plate, a whisker, or be part of a plurality that includes combinations of two or more thereof. In one embodiment, a cross-sectional geometry of the particle may be one or more of circular, ellipsoidal, triangular, rectangular, or polygonal.

In one embodiment, the filler may be fibrous. A fibrous material may include one or more fibers and may be configured as a thread, a strand, yarn, a mat, a fabric, a woven roving, or a continuous filament. In one embodiment, a fibrous material may include one or more fiber having high strength. In one embodiment, a fibrous material may include continuous fibers. In one embodiment, a fibrous material may include discontinuous fibers. The strength of the fibers may be further increased by forming a plurality of layers or plies, by orientation of the fibers in a direction, and like methods.

With further reference to the material suitable to form the fibers, glass, ceramic, metal, and cermet are suitable. Examples of suitable glass fibers may include E-glass or S-glass fiber. Suitable examples of fibers may include, but are not limited to, glass fibers (for example, quartz, E-glass, S-2 glass, R-glass from suppliers such as PPG, AGY, St. Gobain, Owens-Corning, or from Johns Manville).

With regard to fibers that are carbonaceous, a suitable fiber may include a polymer. Suitable polymers may include one or more of polyester, polyamide (for example, NYLON polyamide available from E.I. DuPont, Wilmington, Del.), aromatic polyamide (such as KEVLAR aromatic polyamide available from E.I. DuPont; or P84 aromatic polyamide available from Lenzing Aktiengesellschaft, Austria), polyimide (for example, KAPTON polyimide available from E.I. DuPont,), or polyolefins. Suitable polyolefins may include extended chain polyethylene (for example, SPECTRA polyethylene from Honeywell International Inc., Morristown, N.J.; or DYNEEMA polyethylene from Toyobo Co., Ltd., Tokyo, Japan), and the like.

Other suitable carbonaceous fibers may include carbon fiber. Suitable examples of carbon fibers may include, but are not limited to, AS2C, AS4, AS4C, AS4D, AS7, IM6, IM7, IM9, and PV42/850 from Hexcel Corporation; TORAYCA T300, T300J, T400H, T600S, T700S, T700G, T800H, T800S, T1000G, M35J, M40J, M46J, M50J, M55J, M60J, M30S, M30G, and M40 from Toray Industries, Inc; HTS12K/24K, G30-500 3K/6K/12K, G30-500 12K, G30-700 12K, G30-700 24K F402, G40-800 24K, STS 24K, HTR 40 F22 24K 1550tex from Toho Tenax, Inc; 34-700, 34-700WD, 34-600, 34-600WD, and 34-600 unsized from Grafil Inc.; T-300, T-650/35, T-300C, and T-650/35C from Cytec Industries.

In one embodiment, the filler may include aggregates or agglomerates prior to incorporation into the composition, or after incorporation into the composition. An aggregate may include more than one filler particle in physical contact with one another, while an agglomerate may include more than one aggregate in physical contact with one another. In some embodiments, the filler particles may not be strongly agglomerated and/or aggregated such that the particles may be relatively easily dispersed in the polymeric matrix.

Optionally, the filler may be subjected to mechanical or chemical processes to improve the dispersibility of the filler in the polymer matrix. In one embodiment, the filler may be subjected to a mechanical process, for example, high shear mixing prior to dispersing in the polymer matrix. In one embodiment, the filler may be chemically treated prior to dispersing in the polymeric matrix.

Chemical treatment may include removing polar groups from one or more surfaces of the filler particles to reduce aggregate and/or agglomerate formation. Chemical treatment may also include functionalizing one or more surfaces of the filler particles with functional groups that may improve the compatibility between the fillers and the polymeric matrix, reduce aggregate and/or agglomerate formation, or both improve the compatibility between the fillers and the polymeric matrix and reduce aggregate and/or agglomerate formation. In some embodiments, chemical treatment may include applying a sizing composition to one or more surface of the filler particles.

In one embodiment, an article may include a coupling agent composition. A coupling agent composition is capable of bonding to a filler having a corresponding binding site. As used herein, the term “coupling agent” refers to a material that may provide for an improved interface or adhesion between the filler and a polymeric material.

The filler binding sites may include functional groups that may react or interact with the coupling agent composition to result in bond formation. As described hereinabove, in some embodiments, binding sites may be capable of covalent bond formation with the coupling agent composition. In other embodiments, binding sites may be capable of physical bond formation with the coupling agent composition, for example, van der Waals interactions or hydrogen bonding.

In one embodiment, suitable binding sites may be intrinsic to the filler, that is, present in the filler because of filler chemistry or processing steps involved in filler fabrication. In one embodiment, suitable binding sites may be included in the filler extrinsically, for example, by chemical treatment post-filler fabrication. In one embodiment, suitable binding sites in the filler may include both intrinsic and extrinsic functional groups. In one embodiment, a filler may include a sizing composition and the sizing composition may include one or more binding sites capable of bonding with the coupling agent composition. In one embodiment, suitable binding sites may include one or more of epoxy groups, amine groups, hydroxyl groups, or carboxylic groups.

In one embodiment, a filler may be present in amount in a range of less than about 10 weight percent of the article. In one embodiment, a filler may be present in amount in a range of from about 10 weight percent to about 20 weight percent of the article, from about 20 weight percent to about 30 weight percent of the article, from about 30 weight percent to about 40 weight percent of the article, or from about 40 weight percent to about 50 weight percent. In one embodiment, a filler may be present in amount in a range of from about 50 weight percent to about 55 weight percent of the article, from about 55 weight percent to about 65 weight percent of the article, from about 65 weight percent to about 75 weight percent of the article, from about 75 weight percent to about 95 weight percent of the article, or from about 95 weight percent to about 99 weight percent of the article. In one embodiment, a filler may be essentially present in amount in a range of from about 20 weight percent to about 80 weight percent of the article. In one embodiment, a filler may be essentially present in amount in a range of from about 40 weight percent to about 80 weight percent of the article.

In one embodiment, the coupling agent composition may be mixed in with the polymer precursor to form the curable composition. The curable composition may be then contacted with the filler. In one embodiment, a filler may include a fibrous material placed in a cavity of a mold. A curable material may be dispensed into the mold to impregnate the fibrous material.

In one embodiment, rather than mixing the coupling agent into the curable composition with the other ingredients, the coupling agent composition may be contacted with filler by coating the filler surface by dipping the fillers in a solution of the coupling agent composition or by spraying the fillers with a solution of the coupling agent composition. Solutions of coupling agent compositions if employed may include solvents having sufficiently volatility to allow for evaporation of the solvent. In one embodiment, a coupling agent composition maybe contacted with the filler using solid-state deposition techniques. If aqueous coupling agents are desired to be used, the aqueous coupling agents can be emulsified to form a water in oil (WO) emulsion. Other emulsions, OW, WOW, and OWO emulsions may be used where appropriate.

In one embodiment, an article fabricated employing the compositions and methods disclosed herein may have a thickness that is greater than about 0.1 millimeters, greater than about 0.5 millimeters, greater than about 1 millimeters, greater than about 0.5 centimeters, greater than about 1 centimeter, greater than about 5 centimeters, or greater than about 10 centimeters.

In one embodiment, a laminate is provided. A laminate may include two or more layers. In one embodiment at least one layer may include a post-cured polymer. A post-cured polymer may include a reaction product of a filler having binding sites and a curable composition including a coupling agent composition, a polyfunctional cycloolefin, a monofunctional cycloolefin (if present) and a metathesis catalyst. In one embodiment, the two or more layers may be bonded to each other. In one embodiment, a laminate may include at least one adhesive layer bonding the two or more layers.

In one embodiment, a cured composite structure is provided. A cured composite structure may include a filler and a post-cured polymer as described hereinabove.

A cured composite structure may have mechanical properties, thermal properties, or chemical properties selected based on the end-use requirements. In one embodiment, a cured resin in the composite structure may have a tensile modulus in a range of from about 250,000 pounds per square inch (psi) to about 300,000 pounds per square inch (psi), from about 300,000 pounds per square inch (psi) to about 400,000 pounds per square inch (psi), from about 400,000 pounds per square inch (psi) to about 500,000 pounds per square inch (psi), from about 500,000 pounds per square inch (psi) to about 600,000 pounds per square inch (psi), or from about 600,000 pounds per square inch (psi) to about 700,000 pounds per square inch (psi).

Compression strength for the composite structure may be measured using ASTM method D6641. In one embodiment, the composite structure may include a fibrous material and the fibers may be present in a direction parallel to the load during the test (0 degrees) and perpendicular to the load direction during the test (90 degrees direction). In one embodiment, a cured composite structure made with half the fibers in the 0 degree direction and half in the 90 degree direction may have a compression strength in a range of from about 30 kilo pounds per square inch (ksi) to about 40 kilo pounds per square inch (ksi), from about 40 kilo pounds per square inch (ksi) to about 50 kilo pounds per square inch (ksi), from about 50 kilo pounds per square inch (ksi) to about 60 kilo pounds per square inch (ksi), from about 60 kilo pounds per square inch (ksi) to about 70 kilo pounds per square inch (ksi), from about 70 kilo pounds per square inch (ksi) to about 80 kilo pounds per square inch (ksi), from about 80 kilo pounds per square inch (ksi) to about 90 kilo pounds per square inch (ksi), or from about 90 kilo pounds per square inch (ksi) to about 100 kilo pounds per square inch (ksi).

Toughness value for the composite structure may be measured using ASTM D5528-01 method for Mode I and an internally developed test using end-notch-flexure technique for Mode II. In one embodiment, the cured composite structure may have a toughness value in Mode I in a range of from about 2 pounds per inch to about 5 pounds per inch, from about 5 pounds per inch to about 10 pounds per inch, from about 10 pounds per inch to about 15 pounds per inch, or from about 15 pounds per inch to about 20 pounds per inch. In one embodiment, the cured composite structure may have a toughness value in Mode II in a range of from about 5 pounds per inch to about 10 pounds per inch, from about 10 pounds per inch to about 20 pounds per inch, from about 20 pounds per inch to about 30 pounds per inch, from about 30 pounds per inch to about 40 pounds per inch, or from about 40 pounds per inch to about 50 pounds per inch.

In one embodiment, a cured composite structure may be chemically resistant. In one embodiment, a cured composite structure may exhibit chemical resistance desired for the specific end-use. In one embodiment, chemical resistance may be defined as less than 15 percent reduction in compression strength after exposure to chemicals such as methyl ethyl ketone, acids, hydraulic fluids such as Skydrol, detergent, or engine fuels.

In one embodiment, a method is provided. A method includes initiating a metathesis polymerization of a polyfunctional cycloolefin by a metathesis catalyst. In one embodiment, a method may include initiating a ring opening metathesis polymerization reaction of the polyfunctional cycloolefin, the monofunctional cycloolefin, or both the polyfunctional cycloolefin and the monofunctional cycloolefin.

In one embodiment, a method may include heating a curable composition including the cycloolefin(s) and the metathesis catalyst to form a cured polymer, wherein cured polymer is as described hereinabove. In one embodiment, a curable composition may be heated to a first temperature in a range of from about 20 degrees Celsius to about 30 degrees Celsius, from about 30 degrees Celsius to about 40 degrees Celsius, from about 40 degrees Celsius to about 50 degrees Celsius, from about 50 degrees Celsius to about 60 degrees Celsius, from about 60 degrees Celsius to about 75 degrees Celsius, from about 75 degrees Celsius to about 90 degrees Celsius, or from about 90 degrees Celsius to about 100 degrees Celsius. In one embodiment, a curable composition including the cycloolefin(s) and the metathesis catalyst may be heated to a first temperature for a sufficient duration of time such that a cured polymer is formed.

The method includes post-curing the resulting polymer at a temperature that is greater than an onset temperature for secondary curing of the polymer. In one embodiment, the cured polymer may be post-cured at a temperature in a range of from about 250 degrees Celsius to about 260 degrees Celsius, from about 260 degrees Celsius to about 270 degrees Celsius, from about 270 degrees Celsius to about 280 degrees Celsius, from about 280 degrees Celsius to about 290 degrees Celsius, or from about 290 degrees Celsius to about 300 degrees Celsius. In one embodiment, a cured polymer may be post-cured at a temperature in a range that is greater than about 300 degrees Celsius and less than the decomposition temperature of the cured polymer. In one embodiment, a cured polymer may be post-cured for a sufficient duration of time such that a post-cured polymer is formed.

In one embodiment, a method may include contacting a filler with a curable composition including a coupling agent composition (if present), a polyfunctional cycloolefin, a monofunctional cycloolefin (if present), and a metathesis catalyst. In one embodiment, a filler may include a fibrous material placed in a cavity of a mold. A curable composition may be dispensed into the mold to impregnate the fibrous material. In one embodiment, a method may include impregnating a fibrous material with a curable composition including the polyfunctional cycloolefin and the metathesis catalyst. The resulting structure may be then subjected to curing and post-curing conditions as described herein.

In one embodiment, a method may include fabricating the curable composition into an article of a desired shape or size by a molding technique. In one embodiment, a molding technique may include one or more of resin transfer molding (RTM), reaction injection molding (RIM), structural reaction injection molding (SRIM), vacuum-assisted resin transfer molding (VARTM), thermal expansion transfer molding (TERM), resin injection recirculation molding (RICM), controlled atmospheric pressure resin infusion (CAPRI) or Seeman's composite resin infusion molding (SCRIMP). In one embodiment, a method may essentially include fabricating the article by resin infusion method. In one embodiment, a method may essentially include fabricating the article by vacuum-assisted resin transfer molding.

### EXAMPLES

The following examples only illustrate methods and embodiments in accordance with the invention, and do not impose limitations upon the clauses. Unless specified otherwise, all ingredients are commercially available from such common chemical suppliers as Alpha Aesar, Inc. (Ward Hill, Mass.), or Sigma-Aldich Co. (St. Louis, Mo.). A polyfunctional cycloolefin (DPHNE) having a formula (XXII) is synthesized from commercially available cyclopentadiene and dipentaerythritol penta/hexa-acrylate.

### Example 1

### Post-Cure Reaction of DCPD Observed by Differential Scanning Calorimetry (DSC)

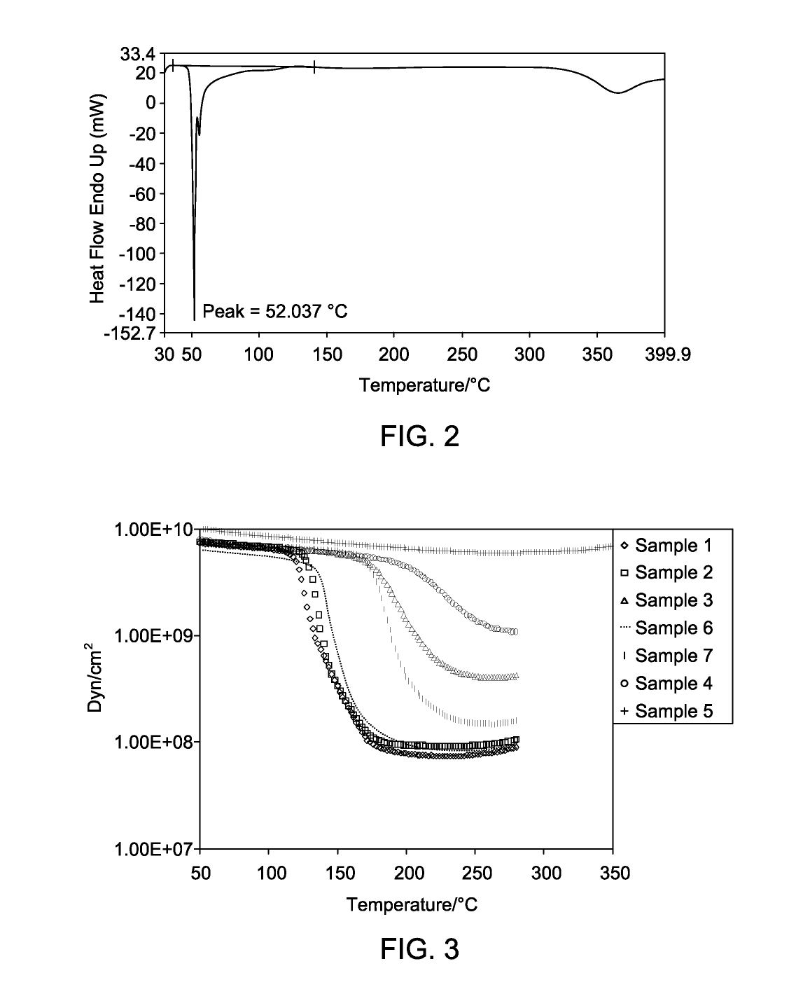

An amount that is 8.5 milligrams of 1,3-Bis(2,4,6-trimethylphenyl)-2-imidazolidinylidene)dichloro(phenylmethylene)(tricyclohexylphosphine)ruthenium is dissolved in 0.45 grams of toluene before being mixed with 8.51 grams of dicyclopentadiene at 35 degrees Celsius. A sample of the resulting mixture is transferred to the differential scanning calorimeter (DSC) instrument (heating rate of 10° C./min) and the resulting thermogram is shown in FIG. 2. An onset temperature for ROMP reaction is observed about 49 degrees Celsius with a peak exotherm at about 52 degrees Celsius. The ROMP reaction is complete below 150 degrees Celsius and no further reaction is observed before 300 degrees Celsius. A second exothermic reaction is observed having an onset temperature greater than about 325 degrees Celsius.

### Example 2

### Post-Cure of DCPD at Different Post-Cure Temperatures

An amount that is 1 weight part of 1,3-Bis(2,4,6-trimethylphenyl)-2-imidazolidinylidene)dichloro(phenyl methylene)(tricyclohexylphosphine)ruthenium is dissolved in approximately 50 parts of toluene. The resulting solution is added to 1000 parts of melted DCPD at a temperature of about 35 degrees Celsius. After thorough mixing using a magnetic stirrer, the mixture is poured into a TEFLON coated tray and allowed to gel at room temperature. The samples are placed in an oven at about 50 degrees Celsius and heated to a temperature of about 100 degrees Celsius at 10° C./minute. The samples are held at a temperature of 100 degrees Celsius for 10 minutes prior to removal from the oven. Post-cure under air is achieved by placing the samples in a forced air oven at the designated temperature for 5 minutes. Post-cure under nitrogen is achieved by placing the samples in an autoclave, evacuating the autoclave and refilling with nitrogen. The autoclave is heated to the designated temperature and held for 20 minutes before cooling down the autoclave and removing the samples. The samples are cut into 2 inch×0.5 inch strips for analysis by DMA using a band saw; the edges are sanded down to a smooth finish. Table 1 lists the post-cure conditions for Samples 1 to 7.

TABLE 1
Post-cure conditions

| Sample No. | Post-Cure Conditions | Post-cure temperature |
|---|---|---|
| 1 | Air | 200 |
| 2 | Air | 250 |
| 3 | Air | 300 |
| 4 | Air | 325 |
| 5 | Air | 350 |
| 6 | N₂ | 250 |
| 7 | N₂ | 300 |

### Example 3

### Dynamic Mechanical Analyses of Post-Cured DCPD Samples

Resin bars (having dimensions of approximately 2 inch×0.5 inch×0.12 inch) of Samples 1 to 7 are prepared as described above in Example 2. Mechanical properties of the resin bars are measured by Dynamic Mechanical Analyses (DMA) in a TA Instruments RDA 3 model fitted with a torsion rectangular fixture at a frequency of 10 radians/second and a heating rate of 2 degrees Celsius/minute.

FIG. 3 shows the DMA plots for storage modulus as a function of temperature for Samples 1 to 7. FIG. 3 shows that the glass transition temperature (T_{g}) for the post-cured samples is dependent on cure conditions (for example, air or N₂). FIG. 3 also shows that the T_{g} for samples post-cured at temperatures greater than 250 degrees Celsius is higher than T_{g} observed for samples post-cured at 250 degrees Celsius or lower. Sample 5, post-cured at a temperature of 350 degrees Celsius does not show any glass transition temperature even at temperatures greater than 350 degrees Celsius or at temperatures below the decomposition temperature (around 400 degrees Celsius).

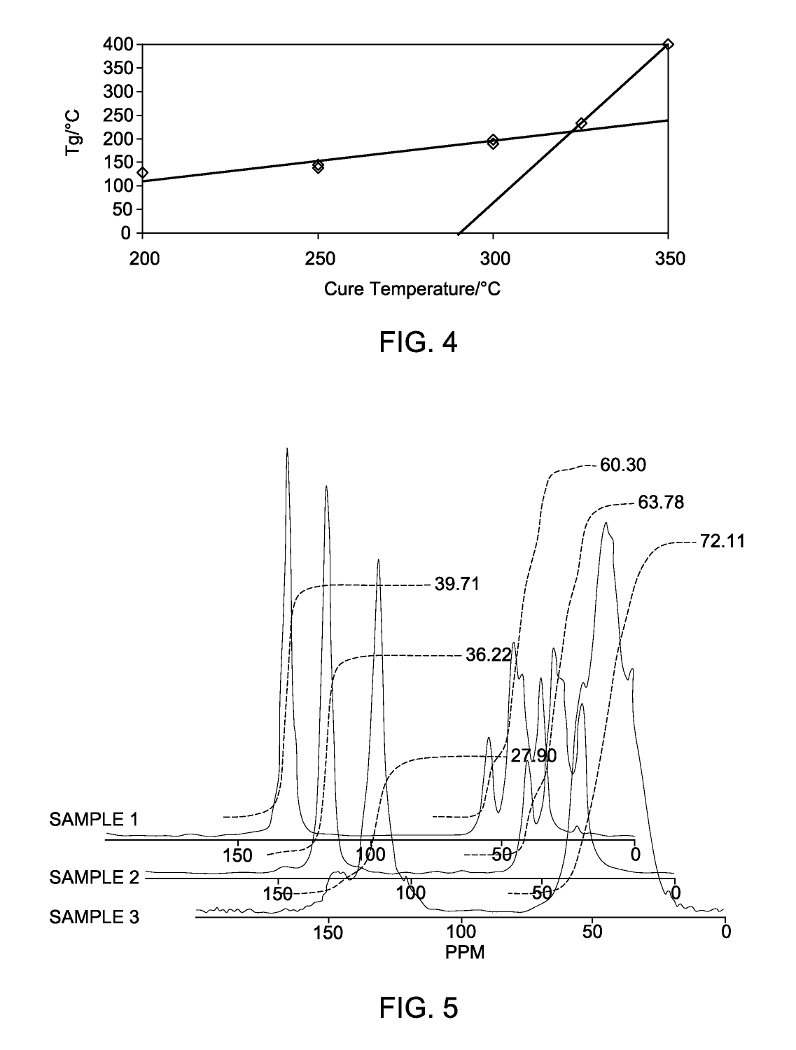

FIG. 4 shows the T_{g} values measured as a function of post-cure temperature for Samples 1 to 7. FIG. 4 shows an almost step change in the T_{g} once a particular post-cure temperature is reached. An intercept of the best-fit curves for the two T_{g} regimes is observed at about 325 degrees Celsius indicating that an onset temperature for the secondary cure reaction may be greater than about 325 degrees Celsius.

### Example 4

### Percentage Olefinic Content in the Post-Cured DCPD Samples

The amount of percentage olefinic content in the post-cured DCPD samples 1, 3, and 5 is determined by solid state ¹³C NMR spectroscopy. FIG. 5 shows the ¹³C NMR spectra for samples 1, 3, and 5. Table 2 lists the percentage olefinic and carbon content as measured by ¹³C NMR and shows that the percentage olefinic content in post-cured DCPD is almost the same as that of a cured DCPD that has not undergone a further crosslinking reaction (about 40 percent). Table 2 also shows that the percentage olefinic content in post-cured DCPD decreases when post-cured at 300 degrees Celsius and further decreases to less than about 30 percent when post-cured at 350 degrees Celsius.

TABLE 2
Percentage carbon content in post-cured DCPD samples

| Sample No. | Olefinic Carbon | Aliphatic Carbon |
|---|---|---|
| 1 | 39.7% | 60.3% |
| 3 | 36.2% | 63.8% |
| 5 | 27.9% | 72.1% |

### Example 5

### Post Cure of DCPD-Polyfunctional Cycloolefin at Differing Post-Cure Temperatures

An amount that is 1 weight part of 1,3-Bis(2,4,6-trimethylphenyl)-2-imidazolidinylidene)dichloro(phenylmethylene)(tricyclohexyl phosphine)ruthenium is dissolved in approximately 50 parts of toluene. This solution is added to 1000 parts of melted DCPD and DPHNE mixture (1:1) at a temperature of about 35 degrees Celsius. After thorough mixing using a magnetic stirrer, the mixture is poured into a TEFLON coated tray and allowed to gel at room temperature. The samples are placed in a forced air oven at about 50 degrees Celsius and heated to the designated post-cure temperature at a rate of 10° C./min and held at the post-cure temperature for 5 minutes before removing the sample from the oven. The samples are cut into 2 inch×0.5 inch strips for analysis by DMA using a band saw; the edges are sanded down to a smooth finish. Two different cure temperatures are employed: 200 degrees Celsius (Sample 8) and 300 degrees Celsius (Sample 9).

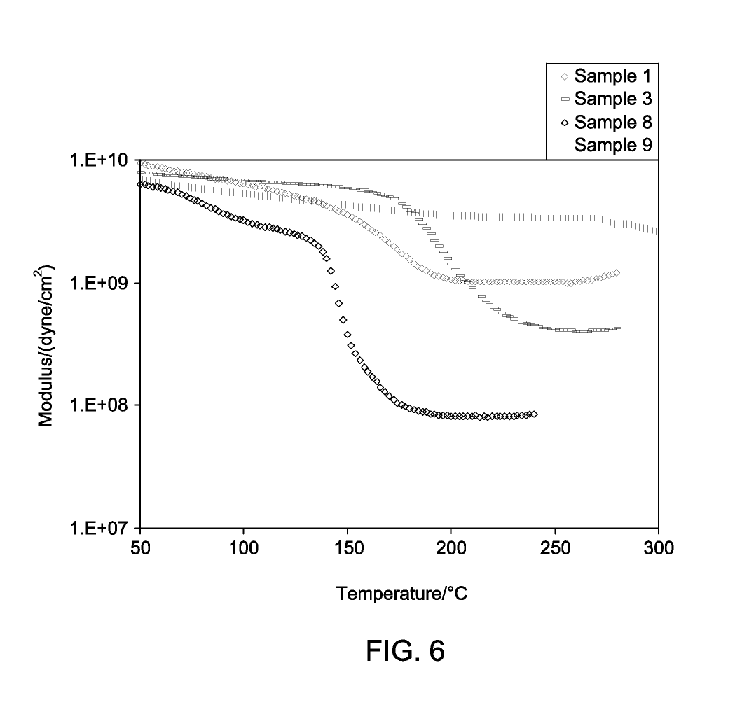

Dynamic mechanical analysis of Samples 8 and 9 is carried out as described in Example 3. FIG. 6 shows the DMA plots for storage modulus as a function of temperature for Samples 1, 3, 8, and 9. FIG. 6 shows that the T_{g} for DPHNE/DCPD samples (samples 8 and 9) post-cured under the same conditions is higher than that observed for DCPD samples (samples 1 and 3). Sample 9, post-cured at a temperature of 300 degrees Celsius does not show any glass transition temperature even at temperatures greater than 350 degrees Celsius or at temperatures below the decomposition temperature (around 400 degrees Celsius).

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

In the specification and the claims, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity can not occur—this distinction is captured by the terms “may” and “may be”.

The foregoing examples are illustrative of some features of the invention. The appended claims are intended to claim the invention as broadly as has been conceived and the examples herein presented are illustrative of selected embodiments from a manifold of all possible embodiments. Accordingly, it is Applicants' intention that the appended claims not limit to the illustrated features of the invention by the choice of examples utilized. As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges there between. It is to be expected that variations in these ranges will suggest themselves to a practitioner having ordinary skill in the art and, where not already dedicated to the public, the appended claims should cover those variations. Advances in science and technology may make equivalents and substitutions possible that are not now contemplated by reason of the imprecision of language; these variations should be covered by the appended claims.

1. A composition, comprising a post-cured polymer formed from a polymer that is a reaction product of:
a polyfunctional cycloolefin comprising two or more metathesis-active double bonds; and
a metathesis catalyst;
wherein the post-cured polymer has a glass transition temperature in a range that is greater than 340 degrees Celsius.

2. The composition as defined in claim 1, wherein the post-cured polymer has a glass transition temperature in a range that is greater than about 400 degrees Celsius.

3. The composition as defined in claim 1, wherein the post-cured polymer has been post-cured at a temperature that is greater than about 300 degrees Celsius.

4. The composition as defined in claim 1, wherein the post-cured polymer has a storage modulus in a range that is greater than about 5×10⁹ dynes/cm² at about 350 degrees Celsius.

5. The composition as defined in claim 1, wherein the polyfunctional cycloolefin comprises a structure having a formula (I): 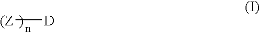
wherein “n” is 2, 3, 4, 5, 6, 7, or 8;
D is a n-valent aliphatic, cycloaliphatic, or an aromatic bridging group; and
Z comprises at least one cycloolefin group.

6. The composition as defined in claim 1, wherein the polyfunctional cycloolefin comprises a structure having a formula (II): 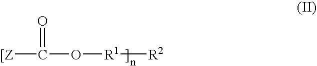
wherein “n” is 2, 3, 4, 5, 6, 7, or 8;
R¹ is an aliphatic radical, a cycloaliphatic radical, or an aromatic radical;
R² is a n-valent aliphatic radical, a cycloaliphatic radical, an aromatic radical; and
Z comprises at least one cycloolefin group.

7. The composition as defined in claim 1, wherein the metathesis catalyst comprises a structure having a formula (XXV): 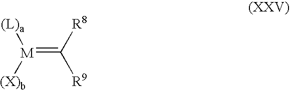
wherein “a” and “b” are independently integers from 1 to 3, with the proviso that “a+b” is less than or equal to 5;
M is ruthenium or osmium;
X is independently at each occurrence an anionic ligand;
L is independently at each occurrence a neutral electron donor ligand;
R⁸ is hydrogen, an aliphatic radical, a cycloaliphatic radical, or an aromatic radical;
R⁹ is an aliphatic radical, a cycloaliphatic radical, an aromatic radical, or S—R¹⁰; or R⁸ and R⁹ together form a cycloaliphatic radical or an aromatic radical; and
R¹⁰ is an aliphatic radical, a cycloaliphatic radical, or an aromatic radical.

8. The composition as defined in claim 1, comprising a monofunctional cycloolefin.

9. The composition as defined in claim 8, wherein the monofunctional cycloolefin comprises a structure having a formula (XXIII): 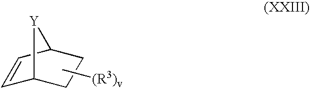
wherein “v” is 1, 2, 3, 4, 5, or 6;
R³ is independently at each occurrence hydrogen, a halogen atom, an aliphatic radical, a cycloaliphatic radical, an aromatic radical, an alkoxy group, a hydroxy group, an ether group, an aldehyde group, an ester group, a ketone group, a thiol group, a disulfide group, an amine group, an amide group, a quaternary amine group, an imine group, an isocyanate group, a carboxyl group, a silanyl group, a phosphanyl group, a sulfate group, a sulfonate group, a nitro group, or two or more R³ together form a cycloaliphatic radical, an aromatic radical, an imide group, or a divalent bond linking two carbon atoms; and
Y is C(R⁴)₂, C═C(R⁴)₂, Si(R⁴)₂, O, S, NR⁴, PR⁴, BR⁴, or AsR⁴, wherein R⁴ is independently at each occurrence hydrogen, an aliphatic radical, a cycloaliphatic radical, or an aromatic radical.

10. The composition as defined in claim 8, wherein the monofunctional cycloolefin comprises one or more of dicyclopentadiene, norbornene, oxanorbornene, norbornadiene, cyclooctadiene, cyclooctene, cyclotetraene, cyclodecene, cyclododecene, or a derivative thereof.

11. An article, comprising the composition as defined in claim 1 and a filler.

12. The article as defined in claim 11, wherein the filler comprises a fibrous material comprising a carbon fiber or a polymer fiber.

13. The article as defined in claim 11, wherein the filler comprises a fibrous material comprising a glass fiber or a ceramic fiber.

14. The article as defined in claim 11, wherein the filler is present in an amount in a range of from about 20 weight percent to 85 weight percent of the article.

15. The article as defined in claim 11, comprising a coupling agent composition.

16. A composition, comprising a post-cured polymer that results from:
metathesis polymerization of a polyfunctional cycloolefin comprising two or more metathesis-active double bonds to form a polymer, and
post-curing the polymer at a temperature that is greater than an onset temperature for secondary curing of the polymer.

17. The composition as defined in claim 16, wherein post-curing the polymer at a temperature that is greater than onset temperature results in an increase in glass transition temperature of the post-cured polymer by greater than about 200 degrees Celsius.

18. The composition as defined in claim 16, wherein the onset temperature is greater than about 250 degrees Celsius.

19. The composition as defined in claim 16, wherein the post-cured polymer has a glass transition temperature that is greater than about 400 degrees Celsius.

20. A composition, comprising a post-cured polymer formed from a polymer that is a reaction product of:
a polyfunctional cycloolefin comprising two or more metathesis-active double bonds; and
a metathesis catalyst,
wherein the post-cured polymer has a glass transition temperature that is greater than 340 degrees Celsius, and the post-cured polymer has an olefinic carbon content that is less than about 35 percent.

21. The composition as defined in claim 20, wherein the post-cured polymer has an olefinic carbon content that is less than about 30 percent.

22. A method, comprising:
initiating a metathesis polymerization of a polyfunctional cycloolefin comprising two or more metathesis-active double bonds; and
post-curing the resulting polymer at a temperature that is greater than an onset temperature for secondary curing of the polymer.

23. The method as defined in claim 22, comprising post-curing the resulting polymer at a temperature that is greater than about 250 degrees Celsius.

24. The method as defined in claim 22, comprising contacting a filler with a curable composition comprising the polyfunctional cycloolefin and a metathesis catalyst.

25. The method as defined in claim 22, comprising impregnating a fibrous material with the curable composition comprising the polyfunctional cycloolefin and the metathesis catalyst.
